(19) United States
(12) Patent Application Publication
(10) Pub. No.: US 2014/0359247 A1
(43) Pub. Date: Dec. 4, 2014

(54) METHOD FOR DATA MANAGEMENT

(71) Applicant: Hsin-Chih Huang, New Taipei City (TW)

(72) Inventor: Hsin-Chih Huang, New Taipei City (TW)

(73) Assignee: ASMEDIA TECHNOLOGY INC., New Taipei City (TW)

(21) Appl. No.: 14/283,222

(22) Filed: May 21, 2014

(30) Foreign Application Priority Data
May 29, 2013 (TW) 102118960

(51) Int. Cl. G06F 12/02

(52) U.S. Cl. CPC G06F 12/023
USPC 711/170

(57) ABSTRACT

A method for data management adapted for a host controller to store device context data of a universal serial bus (USB) device is provided, and the host controller includes a memory. The method includes following steps: storing a device slot index table in the memory; allocating a plurality of memory blocks in the memory according to state information of the USB device when it is detected that the USB device is coupled to the host controller, so as to store the device context data of the USB device, and storing an initial address of the memory blocks in the device slot index table; and releasing the memory blocks and erasing the initial address of the memory blocks stored in the device slot index table when it is detected that the USB device is detached from the host controller.

### CROSS-REFERENCE TO RELATED APPLICATION

This application claims the priority benefit of Taiwan application serial No. 102118960, filed on May 29, 2013. The entirety of the above-mentioned patent application is hereby incorporated by reference herein and made a part of specification.

### BACKGROUND OF THE INVENTION

1. Field of the Invention

The invention relates to a method for data management.

2. Description of the Related Art

Conventionally, an electronic device or a computer system which supports universal serial bus (USB) transmission usually includes a host controller. The host controller maintains one or more groups of device context data according to USB devices coupled thereto, and each group of the device context data corresponds to one USB device.

FIG. 1 is a schematic diagram showing a data structure of conventional device context data. Please refer to FIG. 1, a data structure of the device context data 10 conforms to a standard specification of a USB extensible host controller interface (xHCI). According to the USB xHCI standard specification, the device context data 10 are composed of a storage block 11, a storage block 12 and storage blocks 13_1 to 13_30. The storage block 11 stores slot context data of the USB device, the storage block 12 stores endpoint context 0 data of the USB device, and the storage blocks 13_1 to 13_30 store endpoint context data of an endpoint context 1 IN/OUT to an endpoint context 15 IN/OUT of the USB device. For example, the storage block 13_1 stores the endpoint context 1 OUT data of the USB device, the storage block 13_2 stores the endpoint context 1 IN data of the USB device, the storage block 13_29 stores the endpoint context 15 OUT data of the USB device, and the storage block 13_30 stores the endpoint context 15 IN data of the USB device. Other storage blocks between the storage block 13_2 and the storage block 13_29 can be deduced by analogy.

According to the USB xHCI standard specification, the memory space of each storage block of the device context data 10 is at least 32 bytes. Thus, when one more USB device is coupled thereto, the host controller needs more 1 k bytes memory space to store the device context data 10 correspondingly. However, once the host controller detects a USB device coupled thereto, the device context data 10 shown in FIG. 1 are generated, and the memory space of the host controller would be consumed rapidly.

### BRIEF SUMMARY OF THE INVENTION

A method for data management is provided. The method can dynamically manage device context data maintained by the host controller, and effectively save memory space for storing the device context data.

A method for data management adapted for a host controller to store device context data of at least one universal serial bus (USB) device is provided, and the host controller includes a memory. The method comprising following steps: storing a device slot index table in the memory; allocating a plurality of memory blocks of the memory according to state information of the USB device when that the USB device is coupled to the host controller is detected, so as to store the device context data of the USB device, and storing an initial address of the memory blocks in the device slot index table; and releasing the memory blocks and erasing the initial address of the memory blocks stored in the device slot index table when the USB device is detected being detached from the host controller.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a data structure of conventional device context data;

FIG. 2 is a schematic diagram showing a data management system in an embodiment;

FIG. 3 is a flow chart showing a method for data management in an embodiment;

FIG. 4 is a schematic diagram showing a step of allocating memory blocks in an embodiment;

FIG. 5 is a schematic diagram showing a step of inquiring a first device context data index block in an embodiment;

FIG. 6 is a schematic diagram showing a step of inquiring a slot context queue head block in an embodiment;

FIG. 7 is a schematic diagram showing a step of inquiring an endpoint context queue head block in an embodiment;

FIG. 8 is a schematic diagram showing a step of inquiring sub-endpoint context data blocks in an embodiment;

FIG. 9 is a schematic diagram showing a data management system in another embodiment; and

FIG. 10 is a schematic diagram showing a step of inquiring an endpoint context table according to a pointer in an embodiment.

### DETAILED DESCRIPTION OF THE EMBODIMENTS

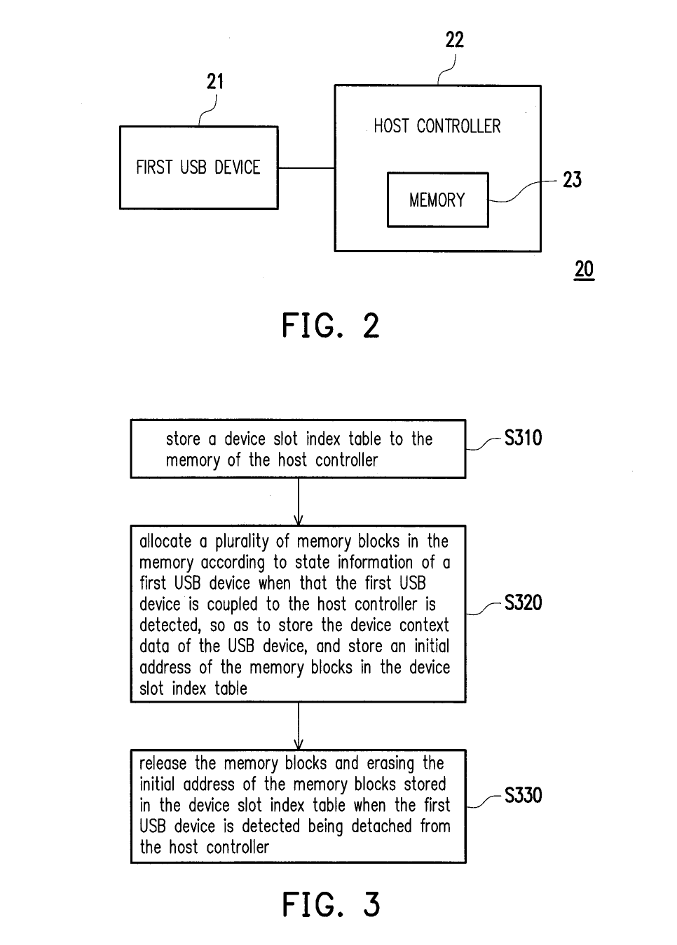

FIG. 2 is a schematic diagram showing a data management system in an embodiment. Please refer to FIG. 2, the data management system 20 includes a first universal serial bus (USB) device 21 and a host controller 22. The first USB device 21 may be an electronic device or a peripheral device which includes a USB transmission interface and supports USB transmission. The number of the first USB device 21 is not limited and is determined according to practical requirements. The host controller 22 may include a micro-controller, an embedded controller or various processors.

The host controller 22 includes a memory 23, and the memory 23 may be a volatile memory, such as a dynamic random access memory (DRAM), or a non-volatile memory. The memory 23 can be disposed in the host controller 22 as a module, or connected to the host controller 22 externally, which is not limited herein. Moreover, the host controller 22 may also include or connect other non-volatile memories to store software or firmware.

FIG. 3 is a flow chart showing a method for data management in an embodiment. The method for data management and the host controller 22 in the embodiment are illustrated with FIG. 2 and FIG. 3.

Please refer to FIG. 2 and FIG. 3, in the step S310, the host controller 22 stores a device slot index table to the memory 23.

Then, in the step S320, when the host controller 22 detects that the first USB device 21 is coupled to the host controller 22, the host controller 22 allocates a plurality of memory blocks in the memory 23 according to the state information of the first USB device 21 to store the device context data of the first USB device 21. For example, the host controller 22 can assess the needed memory space or the number of the needed memory blocks according to endpoint states of the first USB device 21. When the needed memory space or the number of the needed memory blocks is large, the host controller 22 allocates more memory blocks to store the device context data of the USB device 21. On the contrary, when the needed memory space or the number of the needed memory blocks is small, the host controller 22 allocates less memory blocks to store the device context data of the first USB device 21.

Then, the host controller 22 stores an initial address of the memory blocks to the device slot index table. The initial address in the embodiment may be an initial physical address of the memory blocks in the memory 23, and the host controller 22 can find the corresponding memory block and read the data stored in the memory block accordingly.

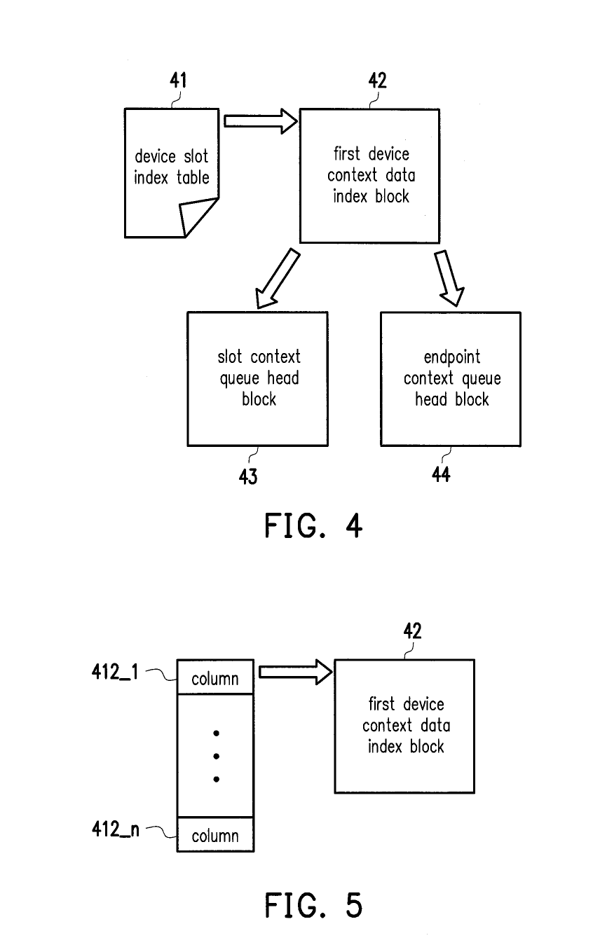

For example, FIG. 4 is a schematic diagram showing the step of allocating the memory blocks in an embodiment. Please refer to FIG. 4, the host controller 22 stores the device slot index table 41 to the memory 23. When the host controller 22 detects the first USB device 21 is coupled to the host controller 22, the host controller 22 allocates available or blank memory blocks, such as a device context data index block 42, a slot context queue head block 43 and an endpoint context queue head block 44, in the memory 23.

The host controller 22 stores the initial address of the first device context data index block 42 to the device slot index table 41, and the initial address of the first device context data index block 42 is regarded as a common initial address of the first device context data index block 42, the slot context queue head block 43 and the endpoint context queue head block 44. Then, the host controller 22 associates the first device context data index block 42, the slot context queue head block 43 and the endpoint context queue head block 44. For example, the host controller 22 can associate the first device context data index block 42 and the slot context queue head block 43, and associate the first device context data index block 42 and the endpoint context queue head block 44. Thus, the host controller 22 can inquire the device slot index table 41 to obtain the initial address of the first device context data index block 42, and find the slot context queue head block 43 and the endpoint context queue head block 44 in the memory 23 according to the association of the first device context data index block 42, the slot context queue head block 43 and the endpoint context queue head block 44.

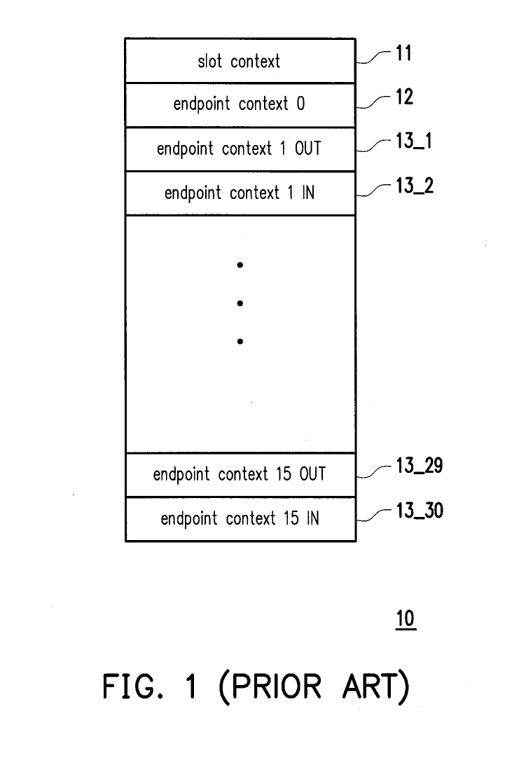

In the embodiment, the first device context data index block 42 is similar with an integrated index block, and it stores the initial address corresponding to each data storage block of the first USB device 21. The host controller 22 can inquire the data in the first device context data index block 42 to find other data storage blocks (such as the slot context queue head block 43 and the endpoint context queue head block 44). The slot context queue head block 43 stores the slot context data (which is similar with the data stored in the storage block 11 in FIG. 1) of the USB device 21. The endpoint context queue head block 44 stores the endpoint context data (which is similar with the endpoint context 0 data of the USB device stored in the storage block 12 in FIG. 1) of the control endpoint (endpoint 0) of the first USB device 21.

The device slot index table 41, the first device context data index block 42, the slot context queue head block 43 and the endpoint context queue head block 44 are illustrated as follows.

FIG. 5 is a schematic diagram showing the step of inquiring the first device context data index block in an embodiment. Please refer to FIG. 5, the device slot index table 41 includes columns 412_1 to 412_n and each of the columns 412_1 to 412_n is used to store the initial address of the first device context data index block corresponding to the USB device coupled to the host controller 22. For example, please refer to FIG. 1 and FIG. 5, when the host controller 22 detects the first USB device 21 is coupled to the host controller 22, the host controller 22 stores the initial address of the first device context data index block 42 corresponding to the first USB device 21 to a blank or an available column (such as the column 412_1) of the device slot index table 41. Thus, the host controller 22 can find the first device context data index block 42 according the information in the column 412_1. After the host controller 22 finds the first device context data index block 42, the host controller 22 can obtain the data of the slot context and each endpoint context stored in the first device context data index block 42.

In the embodiment, each first device context data index block includes a slot context queue head index column and an endpoint context queue head slot column. The slot context queue head index column stores the initial address of the slot context queue head block, and the endpoint context queue head slot column stores the initial address of the endpoint context queue head block.

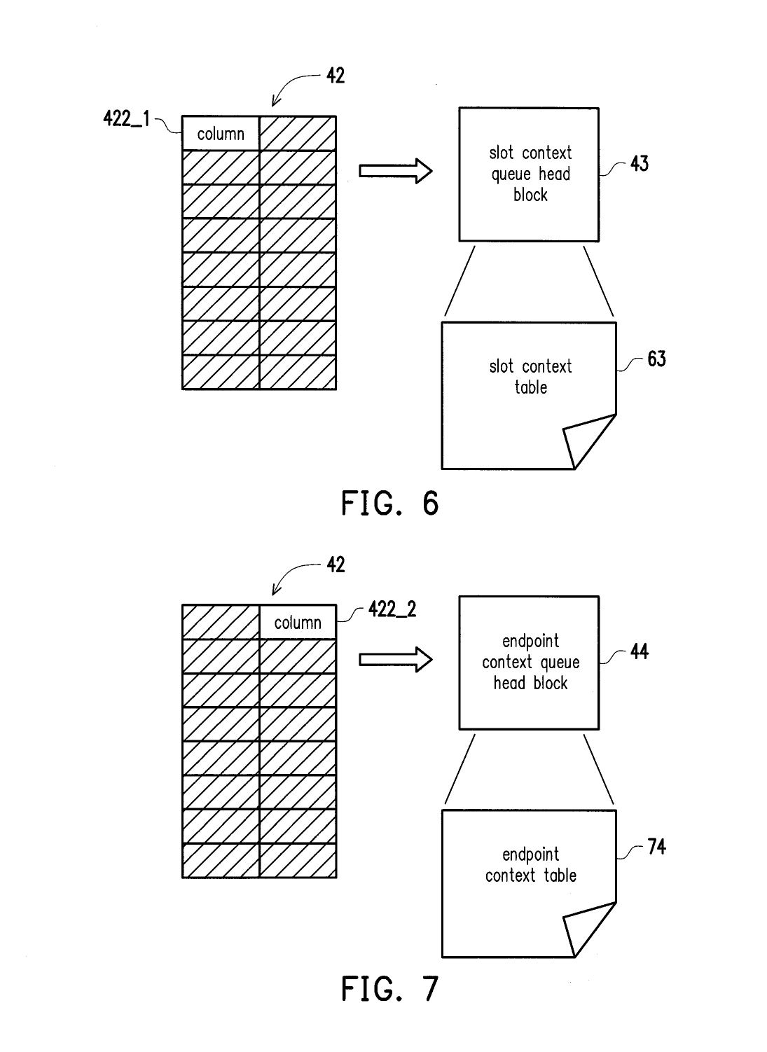

For example, FIG. 6 is a schematic diagram showing the step of inquiring the slot context queue head block in an embodiment. Please refer to FIG. 6, the first device context data index block 42 includes the column 422_1. The column 422_1 is a slot context queue head index column and is used to store the initial address of the slot context queue head block 43. Thus, the host controller 22 can find the slot context queue head block 43 in the memory 23 according to the information in the column 422_1. The slot context queue head block 43 stores a slot context table 63, and the slot context table 63 stores the slot context data of the first USB device 21. After the host controller 22 finds the slot context queue head block 43, the host controller 22 can obtain the slot context table 63.

In another example, FIG. 7 is a schematic diagram showing the step of inquiring the endpoint context queue head block in an embodiment. Please refer to FIG. 7, the first device context data index block 42 also includes a column 422_2. The column 422_2 is a slot context queue head index column and is used to store the initial address of the endpoint context queue head block 44. The host controller 22 can find the endpoint context queue head block 44 in the memory 23 according to the information stored in the column 422_2. Moreover, the endpoint context queue head block 44 stores an endpoint context table 74, and the endpoint context table 74 stores the endpoint context data of the control endpoint of the first USB device 21. After the host controller 22 finds the endpoint context queue head block 44, the host controller 22 can obtain the endpoint context table 74.

In the step S310, the memory blocks allocated by the host controller 22 further includes a plurality of sub-endpoint context data blocks, and the sub-endpoint context data blocks store the endpoint context data of the plurality of sub-endpoints of at least one USB device, such as the first USB device. Taking the embodiment in FIG. 1 as an example, the sub-endpoint context data blocks are similar with the storage block 13_1 to 13_30, and they can store the endpoint context data of the endpoint context 1 IN/OUT to the endpoint context 15 IN/OUT of the USB device.

Additionally, the host controller 22 can adjust the number of the allocated sub-endpoint context data blocks according to the state information of the first USB device 21, which reduces the number of the sub-endpoint context data blocks to save the memory space. For example, the host controller 22 can assess the number of the needed sub-endpoint context data blocks according to the state information of the first USB device 21. Then, the host controller 22 allocates the sub-endpoint context data blocks in the memory 23 according to the assessing result.

In the embodiment, the host controller 22 can dynamically allocate one or more sub-endpoint context data blocks according to whether the endpoint context data of the endpoint context 1 IN/OUT to the endpoint context IN/OUT 15 exist or need to be stored, which makes the number of the sub-endpoint context data blocks correspond to the endpoint context data of the endpoint context 1 IN/OUT to the endpoint context 15 IN/OUT which need to be stored, and it does not need to constantly maintain the storage blocks 13_1 to 13_30 as the device context data 10 in FIG. 1.

Furthermore, the first device context data index block may further include a plurality of first sub-endpoint context data index columns in order to find the sub-endpoint context data blocks. The first sub-endpoint context data index columns are used for storing the initial address of a first part of the sub-endpoint context data blocks (such as the sub-endpoint context data blocks storing the endpoint context data of the endpoint context 1 IN/OUT to the endpoint context 10 IN/OUT).

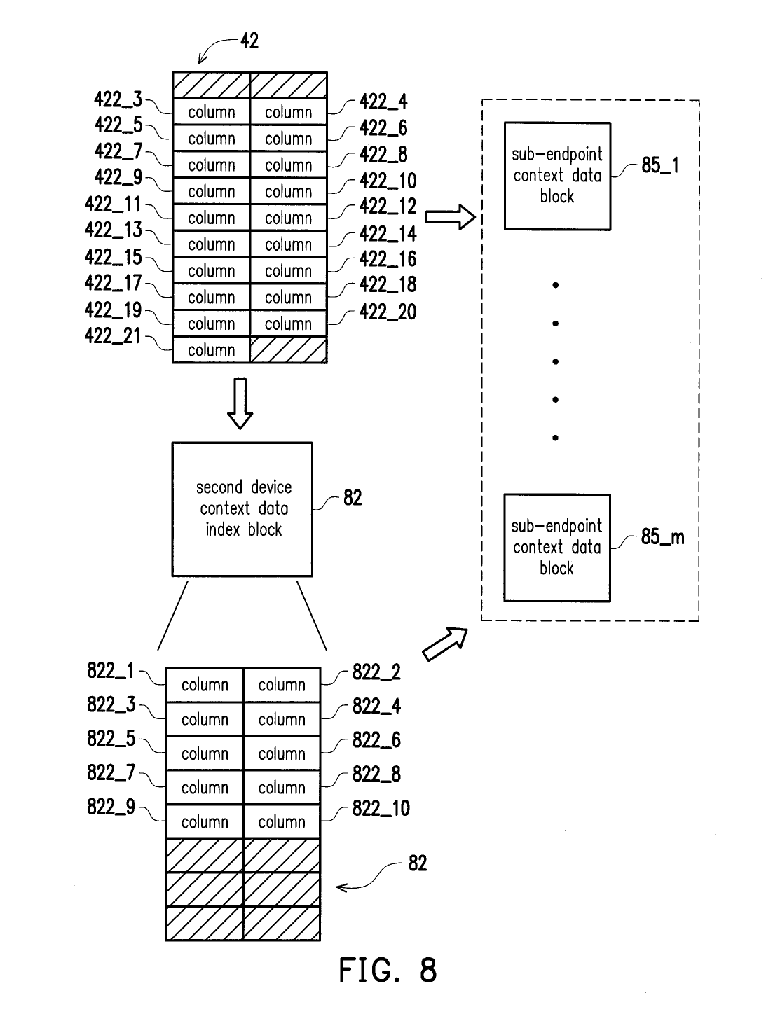

For example, FIG. 8 is a schematic diagram showing the step of inquiring the sub-endpoint context data blocks in an embodiment. Please refer to FIG. 8, the host controller 22 can allocate the sub-endpoint context data blocks 85_1 to 85_m in the memory 23 to store the endpoint context data of the needed endpoint context 1 IN/OUT to the endpoint context 15 IN/OUT, and the number “m” is determined according to whether the endpoint context data of the endpoint context 1 IN/OUT to the endpoint context 15 IN/OUT exist or need to be stored.

The first device context data index block 42 may further include the columns 422_3 to 422_20. The column 422_3 stores the initial address of the sub-endpoint context data block which stores the endpoint context data of the endpoint context 1 IN. The column 422_4 stores the initial address of the sub-endpoint context data block which stores the endpoint context data of the endpoint context 1 OUT. The column 422_5 stores the initial address of the sub-endpoint context data block which stores the endpoint context data of the endpoint context 2 IN. The columns 422_6 to 422_20 can be deduced by analogy. Moreover, due to the limitation of the number of the columns of the first device context data index block 42, the first device context data index block 42 only can store the initial address of the sub-endpoint context data blocks (which is the initial address of the first part of the sub-endpoint context data blocks) of the endpoint context data of the endpoint context 1 IN/OUT to the endpoint context 10 IN/OUT.

In the step S310, in order to store the initial address of the sub-endpoint context data blocks of the endpoint context data of the endpoint context 11 IN/OUT to the endpoint context 15 IN/OUT, the host controller 22 can allocate a second device context data index block 82 to store a plurality of second sub-endpoint context data index columns. The second sub-endpoint context data index column stores the initial address of a second part of the sub-endpoint context data blocks (such as the sub-endpoint context data blocks which store the endpoint context data of the endpoint context 11 IN/OUT to the endpoint context 15 IN/OUT). The host controller 22 can store the initial address of the second device context data index block 82 to the column 422_21 of the first device context data index block 42, and the column 422_21 is an associated column.

The second device context data index block 82 includes the columns 822_1 to 822_10. The column 822_1 stores the initial address of the sub-endpoint context data blocks which store the endpoint context data of the endpoint context 11 IN. The column 822_2 stores the initial address of the sub-endpoint context data blocks which store the endpoint context data of the endpoint context 11 OUT. The column 822_3 stores the initial address of the sub-endpoint context data blocks which store the endpoint context data of the endpoint context 12 IN, and the other columns 822_4 to 822_10 can be deduced by analogy.

Consequently, when the endpoint context data of a part or all of the endpoint context 1 IN/OUT to the endpoint context 10 IN/OUT need to be stored, the host controller 22 allocates the first device context data index block 42 to store the initial address of each sub-endpoint context data block. When the endpoint context data of the USB device which need to be stored include the endpoint context data of the endpoint context 11 IN/OUT to the endpoint context 15 IN/OUT, the host controller 22 allocates the second device context data index block 82 additionally to store the initial address of each sub-endpoint context data block to the first device context data index block 42 and the second device context data index block 82 in the way stated above.

For example, it is assumed that the endpoint 1 IN/OUT and the endpoint 15 IN/OUT of the USB device 21 have a specific function state, and the host controller 22 needs to store the endpoint context data of the endpoint context 1 IN, the endpoint context 1 OUT, the endpoint context 15 IN and the endpoint context 15 OUT of the first USB device 21. The host controller 22 allocates the sub-endpoint context data blocks 85_1 to 85_4 (which means m=4). The sub-endpoint context data blocks 85_1 stores the endpoint context data of the endpoint context 1 IN of the USB device 21. The sub-endpoint context data block 85_2 stores the endpoint context data of the endpoint context 1 OUT of the first USB device 21. The sub-endpoint context data block 85_3 stores the endpoint context data of the endpoint context 15 IN of the first USB device 21. The sub-endpoint context data block 85_4 stores the endpoint context data of the endpoint context 15 OUT of the first USB device 21.

Then, the host controller 22 stores the initial address of the sub-endpoint context data blocks 85_1 to the column 422_3 of the first device context data index block 42, stores the initial address of the sub-endpoint context data blocks 85_2 to the column 422_4 of the first device context data index block 42, stores the initial address of the sub-endpoint context data blocks 85_3 to the column 822_9 of the second device context data index block 82, and stores the initial address of the sub-endpoint context data blocks 85_4 to the column 822_10 of the second device context data index block 82, and thus the host controller 22 can find the sub-endpoint context data blocks 85_1 to 85_4 via the column 422_3, the column 422_4, the column 822_9 and the column 822_10 conveniently.

In the embodiment, only the memory blocks which are needed to store the necessary data are allocated. However, in the device context data 10 in FIG. 1, all memory space is regarded as occupied regardless of whether it is needed, which wastes a part of the memory space which does not store data.

Please refer to FIG. 2 and FIG. 3 again, in the step S330, when the host controller 22 detects that the USB device 21 is detached or pulled out from the host controller 22, the host controller 22 releases the memory blocks and erases the initial address of the memory blocks in the device slot index table. For example, the initial address of the first device context data index block 42 stored in the device slot index table 41 is erased.

On the other hand, when the USB devices are coupled to the host controller, the host controller can also set a pointer in an endpoint context table corresponding to each USB device, and the host controller rapidly obtains and inquires the endpoint context table corresponding to other USB devices according to the pointer.

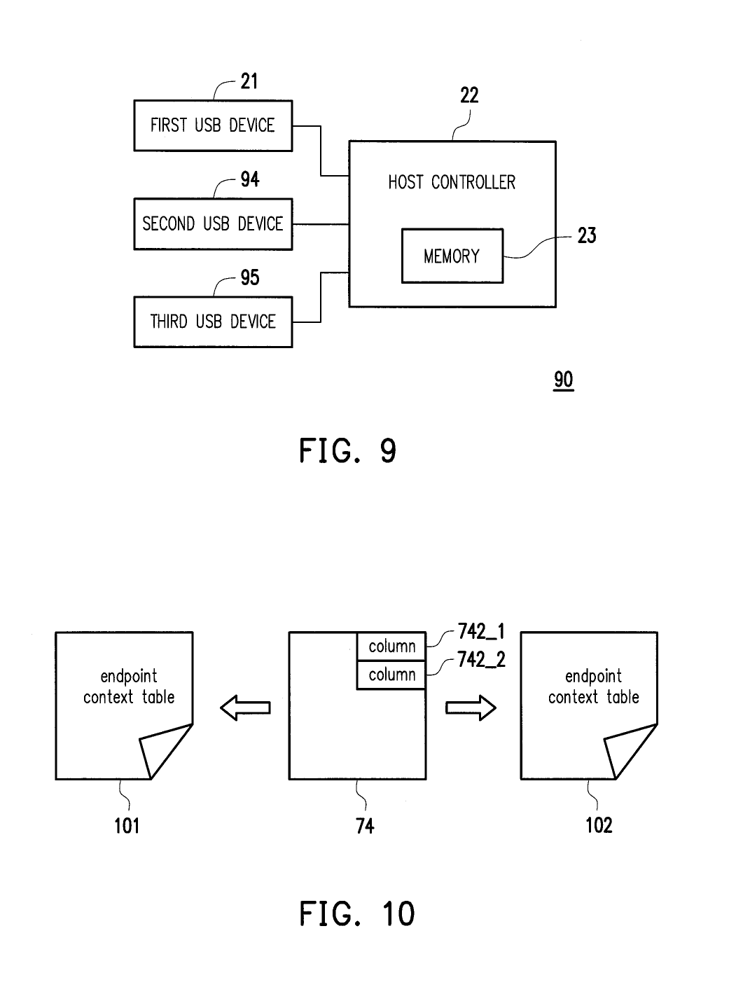

For example, FIG. 9 is a schematic diagram showing a data management system in another embodiment. Please refer to FIG. 9, the data management system 90 includes the first USB device 21, a second USB device 94, a third USB device 95 and the host controller 22, and the host controller 22 includes the memory 23.

The difference between the data management system 90 and the data management system 20 in FIG. 2 is that the host controller 22 in the data management system 90 is further coupled to the second USB device 94 and the third USB device 95. Thus, the host controller 22 can maintain the first device context data index block (and the second device context data index block), the slot context queue head block and the endpoint context queue head block corresponding to the second USB device 94 and the third USB device 95 at the same time.

In order to access the information of the different USB devices and dynamically manage the memory blocks, the host controller 22 can set a forward pointer and a backward pointer, respectively, in the endpoint context table corresponding to the first USB device 21, the second USB device 94 and the third USB device 95. The host controller 22 can find the endpoint context queue head block corresponding to the first USB device 21, the second USB device 94 and the third USB device 95 in the memory 23 according to the forward pointer and the backward pointer in each endpoint context table, and it can inquire the information stored in the endpoint context table of each endpoint context queue head block.

For example, FIG. 10 is a schematic diagram showing the step of inquiring the endpoint context table according to a pointer in an embodiment. Please refer to FIG. 9 and FIG. 10, it is assumed that the endpoint context table 74 is stored in the endpoint context queue head block corresponding to the first USB device 21, the endpoint context table 101 is stored in the endpoint context queue head block corresponding to the second USB device 94, and the endpoint context table 102 is stored in the endpoint context queue head block corresponding to the third USB device 95. The endpoint context table 74 corresponding to the USB device 21 includes a column 742_1 and a column 742_2. The column 742_1 is a forward pointer column, and the column 742_2 is a backward pointer column.

It is assumed that the second USB device 94, the first USB device 21 and the third USB device 95 are coupled to the host controller 22 in sequence. The column 742_1 stores the initial address (which is a forward pointer) of the endpoint context queue head block corresponding to the second USB device 94, and the column 742_2 stores the initial address (which is a backward pointer) of the endpoint context queue head block corresponding to the third USB device 95. Thus, the host controller 22 can find the endpoint context queue head block corresponding to the USB second device 94 according to the forward pointer in the column 742_1 and inquire the endpoint context table 101. The host controller 22 can also find the endpoint context queue head block corresponding to the third USB device 95 according to the backward pointer in the column 742_2 and inquire the endpoint context table 102.

Similarly, the endpoint context table 101 and the endpoint context table 102 can include the forward pointer column and the backward pointer column, respectively. For example, the forward pointer column of the endpoint context table 101 records “Null”, which means the forward pointer in the endpoint context table 101 does not point to other endpoint context tables. The backward pointer column of the endpoint context table 101 records the initial address of the endpoint context queue head block corresponding to the USB device 21. Moreover, the forward pointer column of the endpoint context table 102 can also record the initial address of the endpoint context queue head block corresponding to the USB device 21, and the backward pointer column of the endpoint context table 102 records “Null”, which means the backward pointer in the endpoint context table 102 does not point to other endpoint context tables.

In sum, in the method for data management according to the embodiments, when it is detected that a USB device is coupled to the host controller, the needed the memory space and the number of the needed memory blocks are assessed according to the state information of the USB device. Then, a plurality of the memory blocks in the memory are allocated according to an assess result to store the device context data of the USB device. When it is detected that the USB device is detached from the host controller, the memory blocks are released instantly. Thus, the device context data maintained by the host controller can be dynamically managed, and the memory space for storing the device context data is effectively saved. Furthermore, the endpoint context table corresponding to each USB device can be rapidly inquired by setting a pointer in the endpoint context table, which can reduce reading delay.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A method for data management, adapted for a host controller to store device context data of at least one universal serial bus (USB) device, wherein the host controller includes a memory, the method comprising following steps:
storing a device slot index table in the memory;
allocating a plurality of memory blocks in the memory according to state information of a first USB device of the USB device when the first USB device coupled to the host controller is detected, so as to store the device context data of the first USB device, and storing an initial address of the memory blocks in the device slot index table; and
releasing the memory blocks and erasing the initial address of the memory blocks from the device slot index table when the first USB device is detected being detached from the host controller.

2. The method for data management according to claim 1, wherein the memory blocks include a first device context data index block, a slot context queue head block and an endpoint context queue head block, and the step of storing the initial address of the memory blocks to the device slot index table further includes:
storing the initial address of the first device context data index block to the device slot index table as the initial address of the memory blocks.

3. The method for data management according to claim 2, wherein the first device context data index block includes a slot context queue head index column and an endpoint context queue head slot column, and
wherein the slot context queue head index column stores the initial address of the slot context queue head block, and the endpoint context queue head slot column stores the initial address of the endpoint context queue head block.

4. The method for data management according to claim 3, wherein the slot context queue head block stores a slot context table, and the slot context table stores slot context data of the first USB device.

5. The method for data management according to claim 3, wherein the endpoint context queue head block stores an endpoint context table, and the endpoint context table stores endpoint context data of a control endpoint of the first USB device.

6. The method for data management according to claim 5, wherein the endpoint context table includes a forward pointer column and a backward pointer column, the forward pointer column is used to store the initial address of the endpoint context queue head block corresponding to a second USB device of the USB device, and the backward pointer column is used to store the initial address of the endpoint context queue head block corresponding to a third USB device of the USB device.

7. The method for data management according to claim 3, wherein the memory blocks further includes a plurality of sub-endpoint context data blocks, and the sub-endpoint context data blocks store endpoint context data of a plurality of sub-endpoints of the first USB device, and
wherein the first device context data index block stores the initial address of a first part of the sub-endpoint context data blocks.

8. The method for data management according to claim 7, wherein the memory blocks further include a second device context data index block, and the second device context data index block stores the initial address of a second part of the sub-endpoint context data blocks, and
wherein the first device context data index block further stores the initial address of the second device context data index block.

9. The method for data management according to claim 7, wherein the step of allocating the memory blocks of the memory according to the state information of the first USB device includes:
assessing the number of the required sub-endpoint context data blocks according to the state information of the first USB device; and
allocating the sub-endpoint context data blocks of the memory according to the assessed number of the required sub-endpoint context data blocks.
